(19) United States
(12) Patent Application Publication
(10) Pub. No.: US 2007/0020140 A1
(43) Pub. Date: Jan. 25, 2007

(54) Decontamination of biological microbes using metal cations suspended in ethanol

(76) Inventors: Tony L. Buhr, King George, VA (US); Lindsay A. Sobota, Spotsylvania, VA (US); Ryan S. Mackie, Spotsylvania, VA (US); Andrew F. Slaterbeck, King George, VA (US)

Correspondence Address: Naval Surface Warfare Center;Office of Counsel (Patents) (Code XDCI), 17320 Dahlgren Road, Dahlgren, VA, 22448-5100, US

(21) Appl. No.: 11/250,691

(22) Filed: Sep. 20, 2005

Related U.S. Application Data
(60) Provisional application No. 60/702,718, filed on Jul. 25, 2005.

(51) Int. Cl. A01N 25/00

(52) U.S. Cl. 422/19; 424/405

(57) ABSTRACT

A decontamination composition contains a divalent or trivalent metal cation suspended in ethanol, present in an amount of from about 35 wt % or greater, with the option to add surfactant.

### The invention described herein may be manufactured and used by or for the government of the United States of America for governmental purposes without the payment of any royalties thereon or therefore.

### FIELD OF THE INVENTION

The present invention provides a composition and method for decontamination of biological microbes using metal cations, ethanol and a surfactant.

### BACKGROUND

There are numerous strategies for biological decontamination. These include both general and specific decontamination strategies. Most of these methods and treatments use strong chemical reagents in the process. General decontamination strategies include using strong acids, strong bases, strong oxidizers such as Clorox (hypochlorite), or gases such as methyl bromide. The problem with these strategies is that they are environmentally unfriendly, highly toxic, and/or corrosive, which limits their applications. When used in decontamination processes, e.g., processes generally used over large areas of coverage, strong chemicals become problematic as environmentally toxic and hazardous to people. In particular, these options could not be used to decontaminate in situations that necessitated contact of the chemicals with human skin. Specific decontamination strategies would include utilizing enzymes or developing biologically based solutions. The difficulty with specific decontaminants are limited efficacy, especially over a wide temperature range or a short time frame, high costs, limited availability, short shelf lives, and problems related to the decontaminant being readily inactivated.

There is a need in the art to provide an effective and safe methodology for decontamination. The present invention addresses this and other needs.

### SUMMARY

The present invention includes a decontamination composition having a trivalent or divalent metal cation and ethanol present in an amount of from about 35 wt % or greater. The present invention may further include a surfactant.

The present invention also includes a method for decontamination of biological microbes that includes providing a decontamination composition having a metal cation and from about 35 wt % or greater ethanol, and applying the decontamination composition effective for decontamination of the biological microbes. The application of the decontamination composition is useful in biological decontamination or decontamination of persons, e.g., effective in a methodology requiring possible human contact.

### BRIEF DESCRIPTION OF THE DRAWINGS

FIG. 1 is a graph of decontamination of dry-prepared B. atrophaeus subspecies globigii spores for 30 minutes at 25° C.

FIG. 2 is a graph of reproducibility for decontamination of dry-prepared B. atrophaeus subspecies globigii spores using 0.5 M CuCl₂ in 95% EtOH for 30 minutes at 25° C. in 11 independent experiments.

FIG. 3 is a graph of decontamination of dry-prepared B. atrophaeus subspecies globigii spores with copper, ethanol and 1% surfactant for 30 minutes at 25° C. using surfactants (A) Arquad 16/29, (B) Arquad 2C-75, (C) Barlox 12i, (D) Ammonyx LO, (E) sodium lauryl sulfate, (F) BioTerge PAS-85, (G) Amphosol CA and (H) Mirataine CBS.

FIG. 4 is a graph of dry-prepared B. atrophaeus subspecies globigii spores at a concentration of greater than 10⁸ spores/ml were incubated in the presence of Fe⁺³, Zn⁺², Ca⁺², or Cu⁺² suspended in water, 25% ethanol, 50% ethanol, 75% ethanol or 90% ethanol.

FIG. 5 is a graph of wet-prepared B. cereus spores at a concentration of greater than 10⁸ spores/ml were incubated in the presence of Fe⁺³, Zn⁺², Ca⁺², or Cu⁺² suspended in water, 25% ethanol, 50% ethanol, 75% ethanol or 90% ethanol.

### DETAILED DESCRIPTION

The present invention provides a composition and method for decontamination of biological organisms including bacterial endospores, particularly spores produced by Bacillus species. Decontamination, also referred to as decon herein, is the process of killing, removing and/or inhibiting (neutralizing) harmful agents including biological organisms and/or chemicals. The decontamination compositions or solutions of the present invention are particularly applicable for killing bacterial spores. The present invention may be applicable for a large number of decontamination applications including, without limitation, decontamination for the military, medical, industry, agriculture, household areas, from natural causes of contamination or in the event of terrorist attack. The decontamination solutions of the present invention may be used to reduce microbe populations in hospitals, veterinary clinics, farms, dairies, meat processing facilities, hide processing facilities, ships, buildings, houses, automobiles or other vehicles, or other contaminated surfaces and/or areas. The solutions of the present invention are also useful in decontamination as a topical solution for people, such as for skin, hair, clothes, etc., e.g., soldiers or sailors working in biologically contaminated areas. The present decontaminant includes a combination of metal cation, ethanol and preferably a surfactant, and may provide up to a 100% kill of Bacillus endospores within 30 minutes over a wide temperature range, such as from about 0° C. and higher.

As used herein, the terms spores, biological spores, spore populations and similar terminology, refer to contaminant spores that create a hazard, threat, nuisance, etc. by their presence in an environment, on a surface, in food, etc. Typical spores decontaminated by the present invention include, for example, endospores, such as those belonging to the genus Bacillus, Clostridium, and the like. Representative endospore populations include Bacillus and Clostridium species. Some examples are Bacillus subtilis, Bacillus anthracis and Bacillus globigii.

The metal cation of the decontamination composition of the present invention includes one or more trivalent or divalent metal cations. Representative metal cations of the present invention include for example, without limitation, copper (Cu⁺²), chromium (Cr⁺²), vanadium (V⁺³), cobalt (Co⁺²), zinc (Zn⁺²), iron (Fe⁺²), iron (Fe⁺³), and combinations thereof, with Fe⁺³, Fe⁺², Cu⁺², Zn⁺² preferred, Fe⁺³ and Cu⁺² more preferred, and Fe⁺³ most preferred. Representative amounts of the metal cation present in the composition range from about 0.001 M to about 5.0 M, including from about 0.01 M to about 1.0 M, such as from about 0.05 M to about 0.90 M, with about 0.5 M more preferred.

Metal cations are suspended in ethanol that is present in an amount of from about 35 wt % or greater provides a superior decontamination composition compared to metal cations in water. Ethanol, also known as ethyl alcohol or EtOH, has the chemical formula of C₂H₅OH, CAS no. 64-17-5. Ethanol is a chemical compound having a multitude of industrial and commercial applications, including as a precursor in the production of numerous organic chemicals such as ether, butadiene, chloroform, as well as in the production of beverage alcohols, and as a fuel for internal combustion engines. Ethanol is conventionally manufactured for industrial uses by either a process where ethylene is hydrolyzed under various conditions to form ethyl alcohol or an alternative process where ethyl alcohol is produced by the fermentation of sugar with yeast. As such, ethanol production and availability are well known. Ethanol is present in the invention in amounts of from about 35 wt % or greater, more preferably from about 50 wt % or greater of the total composition, and most preferably from about 50 wt % to about 75 wt % of the total composition. Generally, the metal cation in increasing concentrations of ethanol, ethanol at 25%, 50%, 75% and 95% for example, provides increased decontamination efficacy, with optimal ranges of ethanol concentration ranging from 50% to 75% by weight of the composition. Fe⁺³ and Cu⁺² are particularly strong sporicidal cations in the presence of appropriate amounts of ethanol.

In a most preferred embodiment, the decontamination composition of the present invention further includes one or more surfactants. When present, the surfactant(s) preferably is present in an amount of from about 15 wt % or less of the total composition, such as from about 0.1 wt % to about 10 wt %, and preferably present in an amount that forms micelles, which is dependent on specific surfactants. Representative surfactant classes include amine oxide surfactants, cationic surfactants, nonionic surfactants, anionic surfactants, zwitterionic surfactants, neutral or nonionic surfactants, and combinations thereof. Amine oxides are particularly preferred. Preferably the surfactant has carbon chain length of 10 to about 16 carbons. Specific representative surfactants include, for example without limitation, sodium lauryl sulfate, Bio-Terge PAS-8S, Arquad 16/29, Arquad 2C-75, Amphosol CA, Mirataine CBS, Ammonyx LO and Barlox 12i. Preferably, the surfactant is selected for one or more specific processes and used to maximize sporicidal efficacy and minimize damage to the contaminated surface(s), with selection of the surfactant determinable by one skilled in the art of decontamination through ordinary experimentation in light of the disclosure herein.

The decontamination composition of the present invention is applied to a contaminated surface in any appropriate manner that allows effective contact of the decontamination solution to the biological contamination while minimizing damage to the contaminated object, e.g., person, property, etc. After application of the decontamination composition, the composition may be removed by rinsing or wiping prior to a second application of the decontaminate composition, if desired. The present invention is useful in a broad strategy for decontamination of many biological agents, including Bacillus endospores, spores of other bacteria including Clostridium, non-spore forming bacteria regardless of the cell cycle stage, e.g., vegetative bacteria, and many other microbes including fungi and viruses, and possibly toxins.

1. Sporicidal Efficacy of Cu⁺², Ethanol and/or Surfactants Against Dry-Prepared B. atrophaeus subspecies globigii Spores

Dry-prepared spores of non-pathogenic B. atrophaeus subspecies globigii (B. globigii or Bg) were prepared at the Army's Dugway Proving Ground to mimic a bio-weapon, and they are used for bio-weapons studies, including the following experiments. The assay for decontamination experiments was performed with 3-4 replicates and many experiments were reproduced numerous times. The assay included the steps of (1) suspending Bg spores in the appropriate solvent (water or ethanol) at a concentration of 2 mg spores/ml (approximately 2×10⁸ spores/ml) with starting volume of over 1 ml of spores at 2 mg/ml; (2) removing 3 or 4 spore aliquots of 50 ul per aliquot with each aliquot serially diluted in 1x PBS and plated on Luria-Bertani (LB) or Tryptic Soy (TSA) agar plates (this is a control step that gave the spore titer or colony-forming units (CFUs) at Time=0 minutes (T0)); (3) placing the appropriate decontamination solution (2x concentration) aliquoted into each of 3 or 4 eppendorf tubes with 200 ul per tube and then 200 ul of spores were added and mixed to give a final concentration of 1x decontamination solution and 1 mg spores/ml; (4) the spores in decontamination solution were then mixed and incubated for specific time periods and temperatures. A typical incubation was in a room temperature (25° C.) water bath for 30 (or 60) minutes (no agitation was performed during the incubation period in order to mimic real world situations); (5) aliquots of spores from the 3 or 4 replicates were removed after 30 (or 60) minutes with the aliquots serially diluted in 1x PBS and plated on LB or TSA agar plates which gave a CFU at Time=30 minutes (T30) (the titer of live spores after the decontamination test); (6) after removing the aliquots at the 30-minute time point, some test samples were then immediately incubated in a 70° C. water bath for another 30 minutes, the samples were then serially diluted and plated on to LB agar plates to determine the titer after the 70° C. incubation.

### EXAMPLE 1.1

### Spore Decontamination using Cu⁺² Suspended in Water

Bg spores were suspended in 0.5 M copper chloride (CuCl₂ or Cu⁺²) in water with a spore concentration greater than 10⁷ spores per milliliter for 60 minutes at 25° C. Out of 13 independent experiments, the percentage of spores killed ranged from a low of 52% to a high of 99.91% (data not shown). Ten out of the thirteen experiments gave spore kills of greater than 92% (>1 log spore kill).

In addition, 11 experiments were conducted having spores incubated in 0.5 M CuCl₂ for an additional 30 minutes at 70° C. There was 100% kill of spores (>7 logs of kill) during the moderate heat incubation at 70° C. in all 11 experiments. All tests were pH-neutralized to between pH 7-8 with EPPS buffer prior to 70° C. heat. Controls with only water, EPPS, or 1xPBS showed little or no kill at 70° C.

These data indicated that the divalent metal cation Cu⁺² suspended in water, although highly effective at higher temperatures (70° C.), showed large variability and inadequate efficacy at room temperature for decontamination of bacterial endospores.

### EXAMPLE 1.2

### Spore Decontamination using Cu⁺² Suspended in Alcohol

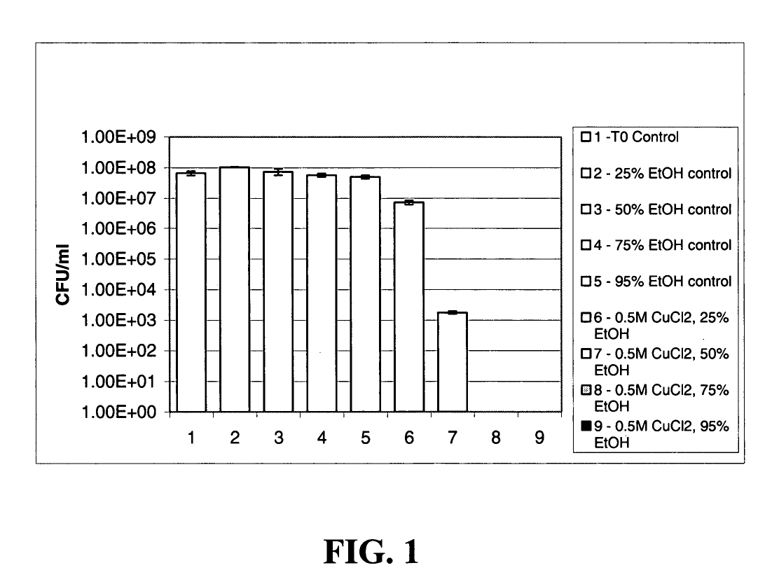

In FIG. 1, decontamination of Bg spores after suspending spores in copper plus ethanol (EtOH) for 30 minutes at 25° C. is shown. The T0 control indicated a starting concentration close to 10⁸ spores/ml. Controls of 25%, 50%, 75% or 95% ethanol without copper had little affect on the viability of spore populations. However, combining Cu⁺² with ethanol showed a strong synergistic effect at room temperature (25° C.). There was over 2 logs (>99%) of spores killed with 0.5 M CuCl₂, 25% EtOH; over 4 logs (>99.99%) of spores killed with 0.5 M CuCl₂, 50% EtOH; and over 7 logs (100%) of spores killed with either 0.5 M CuCl₂, 75% EtOH or 0.5 M CuCl₂, 95% EtOH.

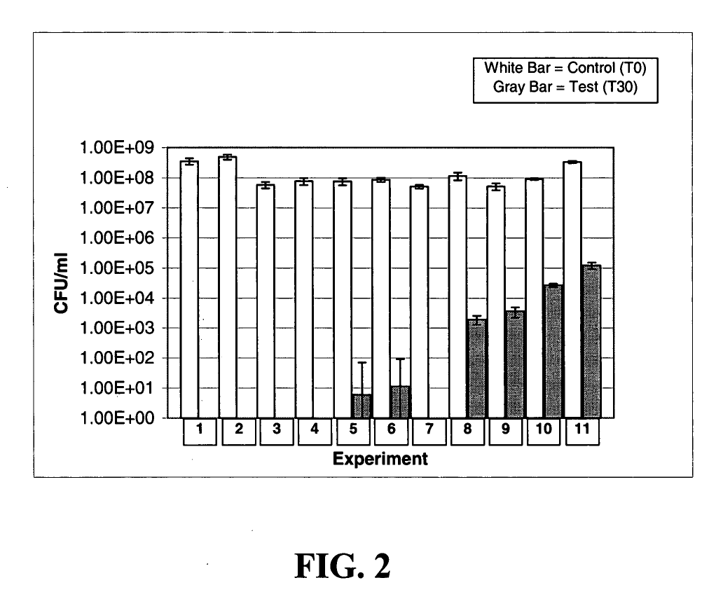

FIG. 2 shows the reproducibility for decontamination of Bg spores using 0.5 M CuCl₂ in 95% EtOH for 30 minutes at 25° C. in 11 independent experiments. Five of the experiments showed 100% spore kill (>7 logs) and seven of the experiments were greater than 6 logs of spore kill. Four experiments had slightly lower sporicidal efficacy (nos. 8, 9, 10 and 11), with efficacy ranging from over 3 logs (>99.9%) up to 5 logs (99.999%) of spore kill. The inconsistency in killing the last 0.1% of spores was likely due to spore clumping as indicated by microscopy (data not shown).

### EXAMPLE 1.3

### Spore Decontamination using Cu⁺² plus Alcohol plus Surfactant(s)

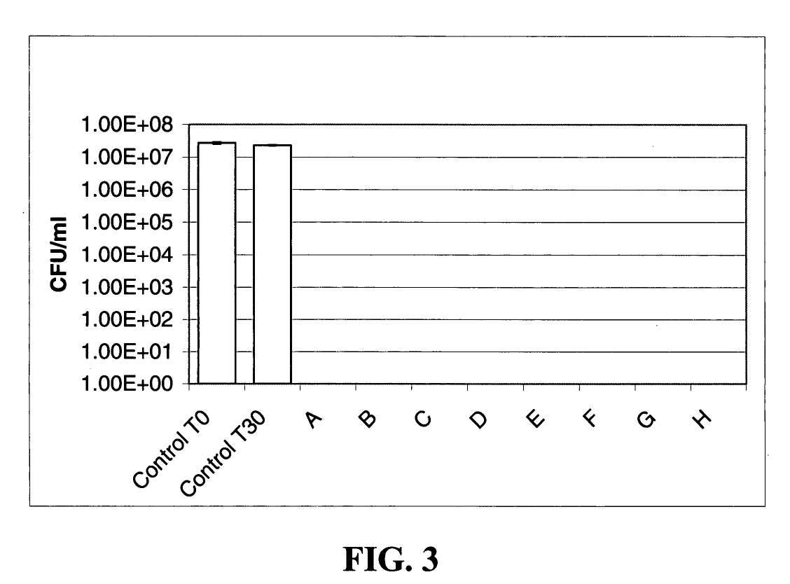

Surfactants were added to reduce spore clumping and increase sporicidal efficacy. Different surfactants, at a final concentration of 1%, were added to Cu⁺² and ethanol formulations to give test solutions of 0.5 M CuCl₂, 90% EtOH and 1% surfactant. Eight different surfactants were tested with each surfactant readily suspended in EtOH solvent plus 0.5 M CuCl₂. The eight surfactants chosen included two anionic surfactants, sodium lauryl sulfate and Bio-Terge PAS-8S; two cationic surfactants, Arquad 16/29 and Arquad 2C-75; two zwitterionic surfactants, Amphosol CA and Mirataine CBS; and two neutral surfactants, Ammonyx LO and Barlox 12i. FIG. 3 shows that each combination of 0.5 M CuCl₂, 90% EtOH and 1% surfactant produced 100% kill of Bg spores. Thus addition of surfactant to the Cu⁺²-ethanol solution improved sporicidal efficacy. As seen in FIG. 3, decontamination of Bg spores with Cu⁺², ethanol and 1% surfactant for 30 minutes, 25° C. showed 100% sporicidal efficacy for a broad range of surfactants: Arquad 16/29; Arquad 2C-75; Barlox 12i; Ammonyx LO; sodium lauryl sulfate; BioTerge PAS-85; Amphosol CA; and Mirataine CBS.

2. Sporicidal Efficacy of Cu⁺², Fe⁺³, Zn⁺², Ca⁺² and Ethanol Against Bacillus cereus and Bacillus atrophaeus subspecies globigii Spores

B. atrophaeus subspecies globigii (B. globigii or Bg) spores from a dried spore preparation were obtained from the Army's Dugway Proving Grounds, Dugway, Utah. B. cereus RSVF1, ATCC 4342 (Bc) was obtained from the American Type Culture Collection, Manassas, Va. Wet spore preparations of Bc were prepared using 2xSG sporulation medium based on published procedures, such as those disclosed in Gutting, B. W., K. S. Gaske, A. S. Schilling, A. F. Slaterbeck, L. Sobota, R. S. Mackie, T. L. Buhr. 2005, Differential susceptibility of macrophage cell lines to Bacillus anthracis-Vollum 1B. Toxicol. In Vitro 19:221-229, the disclosure of which is herein incorporated by reference. Spores were suspended in 0.1x Sigma phosphate-buffered saline (PBS) and treated with lysozyme at 0.5 mg/ml overnight in a shaker/incubator at 25° C., 200 rpm in order to degrade vegetative cell debris to aid spore cleanup. Spores were incubated at 70° C. for 30 minutes to kill any remaining vegetative cells and germinated spores, and to inactivate the lysozyme. Cultures were centrifuged at 3,000xg for 10 minutes, 4° C., and then washed three times with cold sterile water. Spores were suspended in 0.1xPBS at greater than 10⁹ spores/ml, aliquoted into microfuge tubes and stored at −70° C. Prior to storage, spores were examined with microscopy to verify that the preparations contained phase-bright spores. Spore titers were determined by serial dilution and plating on trypticase soy agar (TSA) plates. Spores in wet spore preparations were grown in liquid suspension and never dried.

Assay to quantify spore kills. All experiments were performed with 3-4 replicates. All experiments were reproduced at least twice and many experiments were reproduced numerous times. Bg spores from the dried spore preparation were suspended in ice-cold 0.1×PBS at 10 mg/ml (>1×10⁹ spores/ml), vortexed vigorously for at least one minute, and then set on ice. Wet Bc spore preparations were thawed and then kept on ice.

Decontamination test components included sterile deionized distilled water, 100% ethanol (Sigma), FeCl₃·6H₂O, ZnCl₂, CaCl₂-2H₂O or CuCl₂2H₂O (Sigma), each of which was >97% pure. Each of the cations was suspended in water or ethanol at 1 M.

Decontamination tests and controls were performed in microcentrifuge tubes. 25 μl or 50 μl of spores were added to appropriate volumes of control or test solutions to give a final test volume of 0.25 ml or 0.5 ml, respectively. Final concentrations for controls after adding spores were 100% water, 25% ethanol, 50% ethanol, 75% ethanol or 90% ethanol. Final concentrations for test solutions after adding spores were 0.5 M FeCl₃ in water, 25% ethanol, 50% ethanol, 75% ethanol or 90% ethanol; 0.5 M ZnCl₂ in water, 25% ethanol, 50% ethanol, 75% ethanol or 90% ethanol; 0.5 M CaCl₂ in water, 25% ethanol, 50% ethanol, 75% ethanol or 90% ethanol; 0.5 M CuCl₂ in water, 25% ethanol, 50% ethanol, 75% ethanol or 90% ethanol.

After addition of spores to the appropriate control or test solution, the microcentrifuge tubes were moved to an Eppendorf thermomixer shaking at maximum speed for 15 minutes at 25° C. Samples were then serially diluted in 1x PBS. 100 ml was plated on to TSA plates for the undiluted test solution and for all dilutions. Spore samples were vigorously vortexed just prior to dilution, and just prior to plating, to ensure even suspension of spores. Plates were inverted and incubated between room temperature and 37° C. for at least 14 hours. Several test plates were incubated for over one week to show there was no delayed growth. Plates were enumerated and colony-forming units (CFU) ranging between 29 and 300 were considered significant. CFU averages and standard deviations were then calculated.

An additional decontamination assay was employed to check that results were the result of sporicidal activity and not sporostatic activity. After the 25° C. incubation in the thermomixer, spores were centrifuged at 10,000 xg for one minute and washed with 1 ml of 1xPBS. Spores were washed a total of three times to remove the decontamination solution. Supernatants were saved and 10% of the total supernatant was plated to determine if there were live spores in the supernatant, i.e., spore loss due to washes. Spore pellets were suspended in 220 ml of 1x PBS by vortexing and then promptly serially diluted in 1x PBS. 100 ml was plated on to LB plates for the undiluted test solution and for all dilutions. Spore samples were vigorously vortexed just prior to dilution and just prior to plating to ensure even suspension. Plates were inverted and incubated between room temperature and 37° C. for at least 14 hours. Several test plates were incubated for over one week at 37° C. and examined for delayed growth. Plates were enumerated and CFU ranging between 29 and 300 were considered significant. CFU averages and standard deviations were then calculated.

### EXAMPLE 2.1

### Sporicidal Efficacy of Fe⁺³, Zn⁺², Cu⁺² and Ca⁺² in Ethanol Against Bacillus atrophaeus subspecies globigii Spores

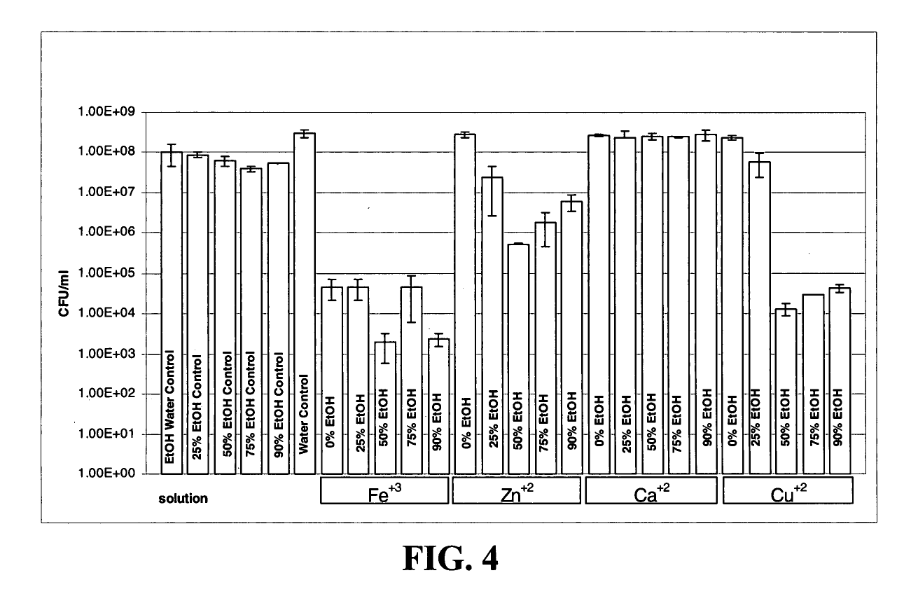

Bg spores were suspended in 0.1x PBS at a concentration of greater than 10⁸ spores/ml, and then incubated in the presence of Fe⁺³, Zn⁺², Ca⁺², or Cu⁺² suspended in water, 25% ethanol, 50% ethanol, 75% ethanol or 90% ethanol. As seen in FIG. 4, Fe⁺³ showed strong activity against dry-prepared Bg spores in water and at any ethanol concentration, reducing the CFU greater than three logs regardless of the solvent. Cu⁺² showed strongest activity in 50%, 75% and 90% ethanol. Zn⁺² also displayed significant activity with greater than two logs CFU reduction in 50% ethanol. Ca⁺² had no affect regardless of the solvent. Similar observations were made with a second assay where spores were washed prior to plating to eliminate the likelihood that results stemmed from bacteriostatic activity (data not shown). In addition, ethanol controls showed little activity against dry-prepared Bg spores.

### EXAMPLE 2.2

### Sporicidal Efficacy of Fe⁺³, Zn⁺², Cu⁺² and Ca⁺² in Ethanol Against Bacillus cereus Spores

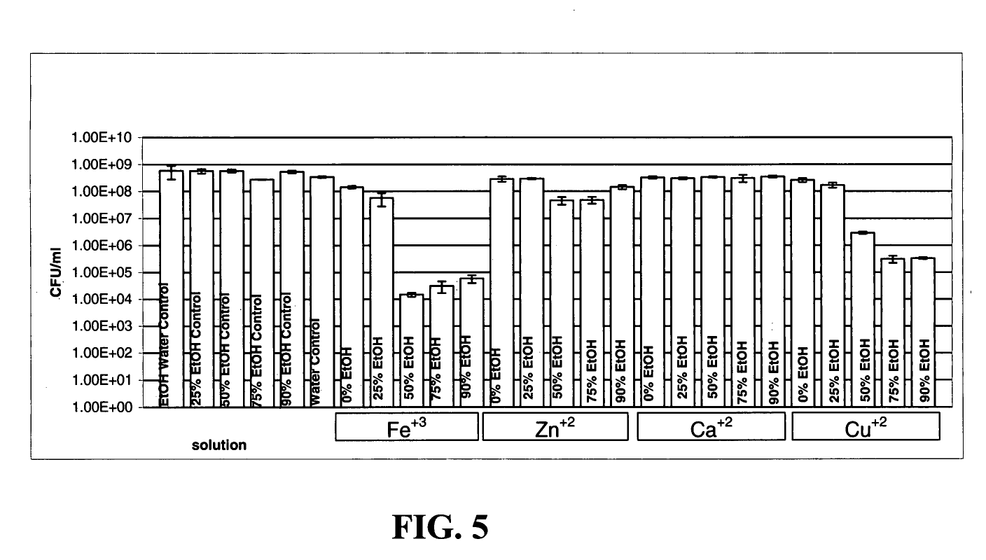

Bc spores from a wet spore preparation were incubated at a concentration of greater than 10⁸ spores/ml in the presence of 0.5 M Fe⁺³, Zn⁺², Ca⁺², or Cu⁺² suspended in 0% ethanol (100% water), 25% ethanol, 50% ethanol, 75% ethanol or 90% ethanol. As seen in FIG. 5, Fe⁺³ in water showed minor activity against Bc spores within 15 minutes, as CFU were reduced by less than half a log relative to the control. None of the other cations suspended in water showed activity against Bc spores. However, there were dramatic changes in efficacy as water was replaced with ethanol. Fe⁺³ suspended in 50%, 75% and 90% ethanol showed greater than three logs (>99.9%) CFU reduction. Cu⁺² also showed strong activity against spores in 50%, 75% and 90% ethanol. Zn⁺² showed slight activity in 50% and 75% ethanol, and Ca⁺² had no affect. Similar observations were made with a second assay where spores were washed prior to plating to eliminate the likelihood that results stemmed from bacteriostatic activity. In addition, ethanol controls showed little activity against Bc spores.

### Applications of the Decontamination Composition(s)

Various methodologies may be used in the application of the decontamination composition of the present invention onto a contaminant. Relevant factors useful in determining the most appropriate conditions to be used include such items as the type of spore species, type of surface or area to be decontaminated, amount of contamination, environmental conditions of the cleanup, and other such criteria that are determinable by those skilled in the art of decontamination. The present invention is useful for numerous decontamination applications. The demonstrations that the decontamination compositions displayed high efficacy against bacterial endospores, one of the most difficult biological agents to kill and decontaminate, are a strong benchmark that the compositions of the present invention will kill many types and forms of microbes is provided. In addition to Bacillus endospores, spores of other bacteria including Clostridium may be decontaminated, in addition to vegetative bacteria and other microbes including bacteria, viruses and fungi. The present invention decontaminates bacterial spores while minimizing environmental or health risks, particularly compared to harsh chemical treatments such as strong acids, or high temperatures such as the steam generated during autoclave sterilization. This allows effective and rapid decontamination of contaminated areas to permit continued safe use of these areas, such as for military or civilian operations. Additionally, the present invention may be useful as a skin decontaminant.

The present invention advantageously provides high sporicidal efficacy, which gives a high kill over a wide temperature range in a very short time frame. The components of the composition are readily and economically available, with the compositions having a relatively long shelf life and high stability. Microbial resistance is minimized, because the combination of components prevents microbial resistance mechanisms from evolving. Microbes also have difficulty in being metabolically active in formulations with over 10% alcohol. 100% kills (>7 logs) were shown within 30 minutes at 25° C. (room temperature) and at 70° C. In addition, a greater than 90% (>1 log) spore kill occurred within a couple of minutes after combining spores with a Cu⁺²-ethanol solution on ice (data not shown). Effectiveness of the methodology of the present invention occurs with increases of biological spore kills with the use of the decontamination composition over non-use. Preferably, an effective kill is variable, depending on the original number of spores within a contamination, such as a 90% effectiveness (kill) against a concentration of 10³ spores/ml, and more preferably an effectiveness of 90% against a concentration of 10⁸ spores/ml, with a most preferred decontamination of from about six or more logarithmic reductions of live spores. Most preferably, the decontamination reduces the spore concentration to a level that renders the once hazardous contaminated area or surface no longer hazardous. Effective biological spore decontamination of these spores rids a contaminated space or object of the immediate hazard occasioned by the spore presence. Spores are killed when they are rendered harmless, i.e., no longer hazardous, to a living organism, particularly a human. Depending on the circumstances, spore decontamination may be desirable against spores that affect other mammals, animals or plants.

Application of the decontamination composition includes any appropriate methodology for exposing the spores, such as by suspending, surrounding, encasing, inundating, engulfing, submerging, misting, or otherwise subjecting the spores to the decontamination composition as to affect the spores thereby. Methodologies may include sprays, mists, liquids, solids and the like. When solutions are applied to a spore population, preferably enough solution is applied to completely immerse the spores in the solution. In one application of the present invention, spores may be harvested and/or trapped by vacuums, filters, glues, etc. to collect and concentrate the spores and placed into a container or similar retaining device. Within the container, the spores are exposed to the decontamination composition, which may be present when the spores were placed in the container or added after placement of the spores, ensuring an appropriate time period to kill and decontaminate the spores. Such decontamination devices may be small, inexpensive and readily transportable, having a resilient container, such as a glass-based, resilient plastic or stainless steel composition, and appropriate heating component for the quantity to be heated, range of temperature to heat, and duration of heating. Preferably decontamination occurs within about 60 minutes, such as 15 minutes, 30 minutes or 45 minutes.

The decontaminated microbe population produced by the present invention overcomes safety issues, particularly health problems, for the effective use of decontaminated surfaces. Additionally, the present invention addresses on-going use of contaminated equipment, such as military aircraft, ships and the like, after decontamination of this equipment. The use of large amounts of the decontamination composition provides effective decontamination without significant health risks associated with other decontaminant procedures.

The foregoing summary, description, and examples of the present invention are not intended to be limiting, but are only exemplary of the inventive features, which are defined in the claims.

What is claimed is:

1. A decontamination composition, comprising:
a divalent or trivalent metal cation; and,
ethanol present in an amount of from about 35 wt % or greater of the total composition.

2. The decontamination composition of claim 1, wherein the metal cation is select from the group consisting of copper (Cu⁺²), chromium (Cr⁺²), vanadium (V⁺³), cobalt (Co⁺²), zinc (Zn⁺²), iron (Fe⁺²), iron (Fe⁺³), and combinations thereof.

3. The decontamination composition of claim 2, wherein the metal cation comprises Fe⁺³.

4. The decontamination composition of claim 1, wherein the metal cation is present in an amount of from about 0.01 M to about 1.0 M.

5. The decontamination composition of claim 1, wherein the ethanol is present in an amount of from about 50 wt % or greater of the total composition.

6. The decontamination composition of claim 5, wherein the ethanol is present in an amount of from about 50 wt % to about 75 wt % of the total composition.

7. The decontamination composition of claim 1, further comprising one or more surfactants.

8. The decontamination composition of claim 7, wherein the one or more surfactants is present in an amount of from about 15 wt % or less of the total composition.

9. The decontamination composition of claim 7, wherein the one or more surfactants is selected from the group consisting of amine oxide surfactant, cationic surfactant, anionic surfactant, nonionic surfactant, and combinations thereof.

10. A skin decontamination composition comprising the decontamination composition of claim 1.

11. A method for decontamination of biological microbes, comprising the steps of:
providing a decontamination composition having a metal cation and from about 35 wt % or greater ethanol; and,
applying the decontamination composition effective for decontamination of the biological microbes.

12. The method of claim 11, wherein the decontamination composition further comprises a surfactant.

13. The method of claim 11, further comprising the step of drying the applied decontamination composition.

14. The method of claim 11, wherein the metal cation is select from the group consisting of copper (Cu⁺²), chromium (Cr⁺²), vanadium (V⁺³), cobalt (Co⁺²), zinc (Zn⁺²), iron (Fe⁺²), iron (Fe⁺³), and combinations thereof.

15. The method of claim 11, wherein the metal cation comprises Fe⁺³.

16. The method of claim 11, wherein the metal cation is present in an amount of from about 0.01 M to about 1.0 M.

17. The method of claim 11, wherein the biological microbes comprises endospores.

18. The method of claim 17, wherein the biological microbes comprises Bacillus endospores.

19. A decontaminated skin product produced by the method of claim 11.

20. A decontaminated ship product produced by the method of claim 11.
